(19) United States
(12) Patent Application Publication
(10) Pub. No.: US 2024/0096051 A1
(43) Pub. Date: Mar. 21, 2024

(54) Determining whether a questionable video of a prominent individual is real or fake

(71) Applicant: DigiCert, Inc., Lehi, UT (US)

(72) Inventors: Naveen Gopalakrishna, Bangalore (IN); Avesta Hojjati, Austin, TX (US)

(73) Assignee: DigiCert, Inc., Lehi, UT (US)

(21) Appl. No.: 18/520,699

(22) Filed: Nov. 28, 2023

Related U.S. Application Data
(63) Continuation-in-part of application No. 18/186,664, filed on Mar. 20, 2023.
Application No. 18/186,664 is a continuation-in-part of application No. 17/660,130, filed on Apr. 21, 2022.

(30) Foreign Application Priority Data
Oct. 16, 2023 (IN) 202341069984

(51) Int. Cl. G06V 10/74; G06V 40/20; G10L 17/26

(52) U.S. Cl. CPC G06V 10/74; G06V 40/23; G10L 17/26

(57) ABSTRACT

Systems and methods are provided for creating authentic baseline data from high-resolution and high-definition audio and video data and for using the authentic baseline data to determine if an unknown video is real or fake. A method, according to one implementation, includes examining a questionable video of a prominent individual, wherein the questionable video shows the prominent individual speaking. The method also includes detecting speech characteristics of the prominent individual from the questionable video and detecting bodily movements of the prominent individual from the questionable video while the prominent individual is speaking. Furthermore, the method includes comparing the detected speech characteristics and detected bodily movements with reliable baseline characteristics that are certified as authentic. Based on the comparing step, the method also includes tagging the questionable video as fake or real.

### CROSS-REFERENCE TO RELATED APPLICATION(S)

The present application is a continuation-in-part of U.S. patent application Ser. No. 18/186,664, filed Mar. 20, 2023, which is a continuation-in-part of U.S. patent application Ser. No. 17/660,130, filed Apr. 21, 2022, the contents of which are incorporate by reference in their entirety.

### FIELD OF THE DISCLOSURE

The present disclosure relates generally to networking and computing. More particularly, the present disclosure relates to systems and methods for inspecting and identifying deep fake videos of a prominent individual.

### BACKGROUND OF THE DISCLOSURE

The term deep fake (also sometimes referred to as deepfake) refers is media such as videos and images that are so realistic, a viewer is often unable to tell it is not real. Deep fake is a combination of the terms “deep learning” and “fake.” Of course, fake content (i.e., video, images, audio, websites, traffic signs, etc.) is not new, but the deep learning aspect leverages machine learning and artificial intelligence techniques to generate content that is more realistic and often very difficult to detect, i.e., real vs. fake. There is a host of problems if we cannot discriminate between real and fake content. For example, political campaigns will no longer need to run attack ads, but rather simply leak a deep fake video of the opponent saying or doing something unfortunate.

There is a need for verification techniques to discriminate between real content and deep fake content.

### BRIEF SUMMARY OF THE DISCLOSURE

The present disclosure relates to systems and methods for identifying deep fake content including videos and images, such as on smart devices, via cameras, and the like. In various embodiments, the present disclosure provides techniques for verification of content, including, e.g., video, images, audio, websites, traffic signs, etc.) with the objective of informing end users of the validity (e.g., with respect to video, images, audio, websites, etc.) as well as autonomous vehicles (e.g., with respect to traffic signs).

In an embodiment, a method of identifying deep fake content includes steps. In another embodiment, a non-transitory computer-readable medium includes instructions that, when executed, cause one or more processors to execute the steps. The steps include receiving content at a smart device; determining whether the content includes a hidden object therein; responsive the content including the hidden object, determining a hash in the hidden object; determining a local hash for the content by the smart device; and determining legitimacy of the content based on the hash in the hidden object and the local hash. The hidden object can be a JavaScript Object Notation (JSON) Web Token (JWT). The JWT can be embedded in the content using Least Significant Bit (LSB) steganography. The smart device can be a smart television and the content is video. The steps can further include determining the legitimacy by verifying a signature of the hidden object with a public key. The steps can further include, prior to the receiving, creating the hidden object using certificates from entities involved with creation of the content. The steps can further include, subsequent to the determining legitimacy, providing a visible indication on the smart device. The content can be a traffic sign and the smart device is a vehicle having one or more cameras.

In a further embodiment, a smart device includes a display communicably coupled to one or more processors; and memory storing instructions that, when executed, cause the one or more processors to receive content to display on the display; determine whether the content includes a hidden object therein; responsive the content including the hidden object, determine a hash in the hidden object; determine a local hash for the content by the smart device; and determine legitimacy of the content based on the hash in the hidden object and the local hash. The hidden object can be a JavaScript Object Notation (JSON) Web Token (JWT). The JWT can be embedded in the content using Least Significant Bit (LSB) steganography. The smart device can be a smart television and the content is video.

According to additional embodiments, a method of identifying deep fake content is further described in the present disclosure. The method includes the step of examining a questionable video of a prominent individual, wherein the questionable video shows the prominent individual speaking. The method also includes the steps of detecting speech characteristics of the prominent individual from the questionable video and detecting bodily movements of the prominent individual from the questionable video while the prominent individual is speaking. Also, the method includes the step of comparing the detected speech characteristics and detected bodily movements with reliable baseline characteristics that are certified as authentic. Based on the comparing step, the method further includes the step of tagging the questionable video as fake or real.

In some embodiments, the reliable baseline characteristics may include authentic speech characteristics and authentic bodily movements derived from a high-resolution video recording of the prominent individual in a controlled setting. The authentic speech characteristics may include high-resolution voice parameters defining how specific phonemes, words, phrases, and/or sentences are spoken by the prominent individual. The authentic bodily movements may include movements of one or more of mouth, face, eyes, eyebrows, head, shoulders, arms, hands, fingers, and chest of the prominent individual when the specific phonemes, words, phrases, and/or sentences are spoken.

For example, the authentic speech characteristics may include parameters related to one or more of pronunciation, enunciation, intonation, articulation, volume, pauses, pitch, rate, rhythm, clarity, intensity, timbre, overtones, resonance, breaths, throat clearing, coughs, and regularity of filler sounds and phrases. The high-resolution video recording, for example, may be created while the prominent individual is performing one or more actions selected from the group consisting of a) reading a script, b) reading a script multiple times within a range of different emotions, c) answering questions, d) answering questions multiple times within a range of different emotions, e) responding to prompts, f) telling a story, g) telling a joke, h) describing something the prominent individual likes, i) describing something the prominent individual dislikes, j) laughing, k) singing, l) smiling, and m) frowning. In addition, the method may also include the step of creating a digital certificate of the high-resolution video recording to certify the high-resolution video recording as authentic.

According to some embodiments, the method may further include the step of detecting parallel correlations between the authentic speech characteristics and the authentic bodily movements. The method may also include the step of using the parallel correlations as training data to create a model defining the reliable baseline characteristics. Furthermore, the method may include the step of determining a percentage of accuracy of the detected speech characteristics and detected bodily movements with respect to the reliable baseline characteristics. When the percentage of accuracy is below a predetermined threshold, the questionable video may be tagged as fake, and, when the percentage of accuracy is above the predetermined threshold, the questionable video may be tagged as real. The step of tagging the questionable video as fake or real may include applying one or more visible and/or hidden watermarks to the questionable video, according to some embodiments. The prominent individual, for example, may be a celebrity, a famous person, a luminary, an actor, an actress, a musician, a politician, and/or an influencer who is important, well-known, or famous.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of a deep fake detection system that contemplates use with the various embodiments described herein.

FIG. 2 is a flowchart of a deep fake detection process for identifying fake content on smart devices.

FIG. 3 is a flowchart of a deep fake detection process for identifying fake traffic signs by smart vehicles.

FIG. 4 is a flowchart of a content publisher signing process.

FIG. 5 is a flowchart of a signing utility process.

FIG. 6 is a flowchart of a verification process implemented by the smart television, the user device, and/or the vehicle.

FIG. 7 is a network diagram of example systems and process flow for a conditional smart seal.

FIG. 8 is a block diagram of a processing system, which may implement any of the devices described herein.

FIG. 9 is a flowchart of a process of identifying deep fake content.

FIG. 10 is a diagram illustrating an embodiment of a controlled setting, such as a studio, for obtaining a high-definition video of a prominent individual.

FIG. 11 is a flow diagram illustrating an embodiment of a method for training a deep fake detection model.

FIG. 12 is a flow diagram illustrating an embodiment of a method for identifying deep fake videos or other artificially created videos, particularly videos of a prominent person speaking.

FIG. 13 is a block diagram illustrating an embodiment of a judging system for inspecting unknown videos.

### DETAILED DESCRIPTION OF THE DISCLOSURE

Again, the present disclosure relates to systems and methods for identifying deep fake content including videos and images, such as on smart devices, via cameras, and the like. In various embodiments, the present disclosure provides techniques for verification of content, including, e.g., video, images, audio, websites, traffic signs, etc.) with the objective of informing end users of the validity (e.g., with respect to video, images, audio, websites, etc.) as well as autonomous vehicles (e.g., with respect to traffic signs).

Of note, the various embodiments described herein relate to automated detection of real and fake content using various techniques. The content can include video, images, audio, websites, traffic signs, etc. Also, of note, while various embodiments are described specifically herein, those skilled in the art will appreciate the techniques can be used together, in combination with one another, as well as each technique can be used individually with the specific use case.

Deep Fake Detection System and Process

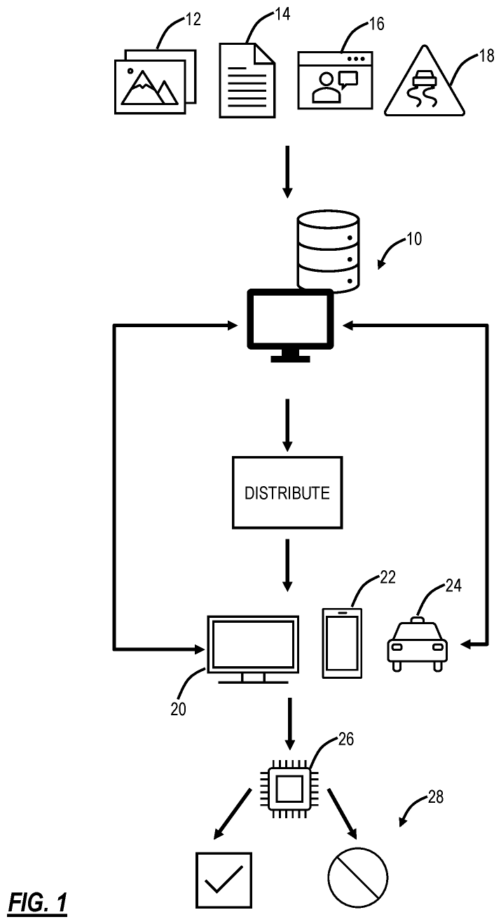

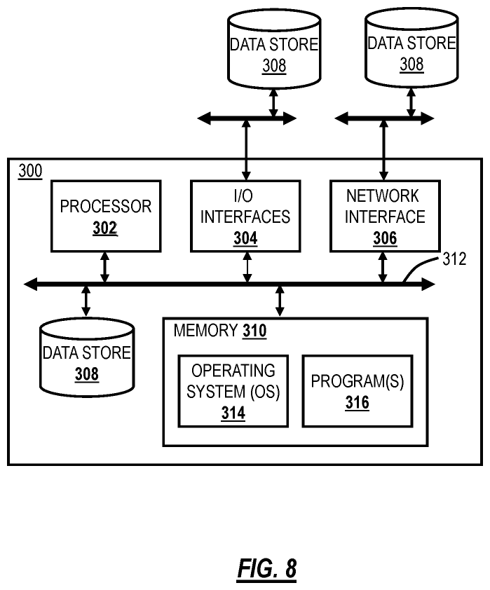

FIG. 1 is a diagram of deep fake detection system 10 that contemplates use with the various embodiments described herein. The deep fake detection system 10 can be a server, a cluster of servers, a cloud service, and the like. FIG. 8 provides an example implementation of a processing device 300 that can be used to physically realize the deep fake detection system 10. FIG. 1 illustrates the detection system 10 and associated process flow for verification of content and subsequent determination whether distributed content is real or fake.

In various embodiments, the content can include pictures 12, text or a file 14, video 16, and a traffic sign 18, collectively content 12, 14, 16, 18. Those skilled in the art will recognize these are some examples of content. Further, the detection system 10 and the subsequent detection of whether the content 12, 14, 16, 18 is real or fake can be dependent on the type of content. For example, the content 12, 14, 16 can be viewed on a smart television 20 or a user device 22, with the smart television 20 or the user device 22 determining whether or not the content 12, 14, 16 is real or not, and performing actions accordingly. In another embodiment, a vehicle 24 can include a camera system configured to detect the traffic sign 18, and to determine whether or not the traffic sign is real or fake based on the various techniques described herein.

A first step in the process flow includes some processing, formatting, and/or embedding data in the content 12, 14, 16, 18, by the deep fake detection system 10. A second step in the process flow includes distribution of the content 12, 14, 16, 18. Those skilled in the art will recognize there can be various types of distribution. For example, the content 12, 14, 16 can be distributed electronically over a network, e.g., the Internet. Also, the content 12, 14, 16 can be broadcast via a streaming service, a television network, etc. The traffic sign 18 is physically distributed, i.e., placed on the side of the road, on an overpass, etc. A third step on the process flow is the end user device, namely the smart television 20, the user device 22, and/or the vehicle 24 performing some analysis 26 of received content 12, 14, 16, 18 and determining 28 whether the content 12, 14, 16, 18 is real or fake (i.e., legitimate or illegitimate). The determining 28 can be made locally at the smart television 20, the user device 22, and/or the vehicle 24, as well as in cooperation with the deep fake detection system 10. Finally, a fourth step in the process flow can include some action at the smart television 20, the user device 22, and/or the vehicle based on the determining 28.

Deep Fake Detection on Smart Devices

Fake news has become a term everyone is familiar with. However, with the proliferation of computing power and machine learning, it is a trivial task to create so-called deep fake content. There has been a proliferation in streaming platforms and video sharing platforms, e.g., YouTube, allowing anyone with a computer to create and post their own content. The main issue with deep fake videos is their incredible ability to convince the audience that the message/connect from the video is from a reliable source. Of course, deep fake videos can be rebutted after they are posted, with crowd sourcing determining a given video is fake. The problem here is the after the fact rebuttal does not convince all users. There is a need to verify the content up front, visibly display the illegitimacy up front, even possibly blocking the content, or allowing the user to proceed after they provide an acknowledgement.

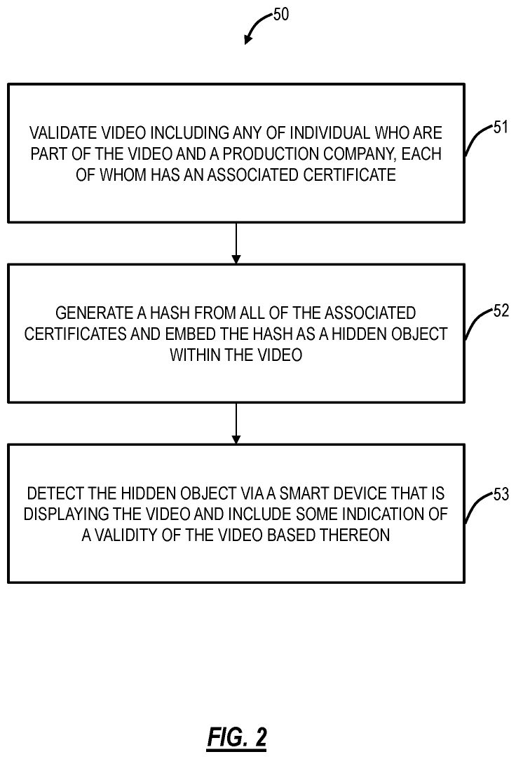

FIG. 2 is a flowchart of a deep fake detection process 50 for identifying fake content on smart devices. The deep fake detection process 50 is described with reference to the various steps in the process flow above. Those skilled in the art will appreciate the steps in the deep fake detection process 50 may occur at different places, systems, processors, etc., and that the claims herein may be written from a single system perspective. That is, the description of the deep fake detection process 50 in FIG. 2 is a process flow, end to end, including steps performed at different locations. Also, the deep fake detection process 50 contemplates implementation with the deep fake detection system 10, the smart television 20, the user device 22, and the like.

The deep fake detection process 50 includes an initial step 51 of validation, where the video 16 is validated based on anyone involved in its production, including individuals who are part of the video 16, a production company associated with the video 16, and the like, each of whom has an associated certificate. Next, the deep fake detection process 50, with the certificates of all involved in the video, includes a stamping step 52 that includes generation of a hash from all of the certificates of all involved in the video and the hash is embedded as a hidden object within the video. The steps 51 and 52 are performed in advance of distribution of the video 16.

Next, in a detection step 53, a smart device including the smart television 20, the user device 22, and the like is configured to detect the hidden object while the video 16 is being played, streamed, accessed, etc., and to include some indication of the validity of the video 16 based thereon. That is, the deep fake detection process 50 seeks to utilize watermarking and similar technologies such as object steganography to embed secret messages within any video postproduction, prior to its release on streaming platforms. The deep fake detection process 50 seeks to (1) validate the individuals or parties who are part of the video and (2) the product company. Once (1) and (2) are determined, we will generate a hash from all of their certificates and place that hash as a hidden object within the video. For example, this can be a JavaScript Object Notation (JSON) Web Token (JWT), such as compliant to RFC 7519, “JSON Web Token (JWT),” May 2015, the contents of which are incorporated by reference in their entirety.

On the user's end, the smart device including the smart television 20, the user device 22, and the like is equipped with screen readers where it will look for that JWT object and if it is presented, the smart device will flag the video as a valid and authentic video, such as via some visual means. Other embodiments are also contemplated, such as blocking invalid videos, presenting the user an option to proceed based on the video being unvalidated, and the like.

Again, the approach in the deep fake detection process 50 is designed so the user is informed in advance of the validity of the video 16, to avoid any audience confusion. Of course, other services provide so-called verification statements related to certain content. However, these are still someone's opinion. For example, rating a social media posting, etc. The deep fake detection process 50 provides a front-end verification that the video 16 comes from a legitimate source. It does not rate the content per se, but rather attests to the fact the video 16 comes from the individuals, the production company, etc. associated with the video 16. That is, the video 16 may still contain false or misleading content, but the end user is assured the video 16 originates from the source and is not a deep fake.

One aspect of the deep fake detection process 50 includes the processing capability on so-called smart televisions 20. Specifically, such devices are more than mere displays for content. Rather, the smart televisions 20 include software, operating systems, and processors, which collectively can be used to detect the hidden object within the video. For example, the smart televisions 20 can be loaded with software and/or firmware for detection and display of validity. The validity can be displayed in any manner, including, e.g., a banner, a seal, a pop up, etc.

Authenticated Traffic Skins

Existing advancements in developing autonomous vehicles has enabled the next generation of such vehicles to be equipped with many sensors such as high definition cameras. Such cameras are being used to collect environmental data such as reading the traffic signs 18 in order to automatically adjust the vehicle's speed, stop at intersections, or slow down if there is a bump on the road. The issue with such approach is that anyone can place a random traffic sign 18 on any road essentially compromising the processing/decision making flow of a smart vehicle 24, resulting in an unexpected outcome such as stopping the vehicle/s in middle of a highway causing catastrophic accidents.

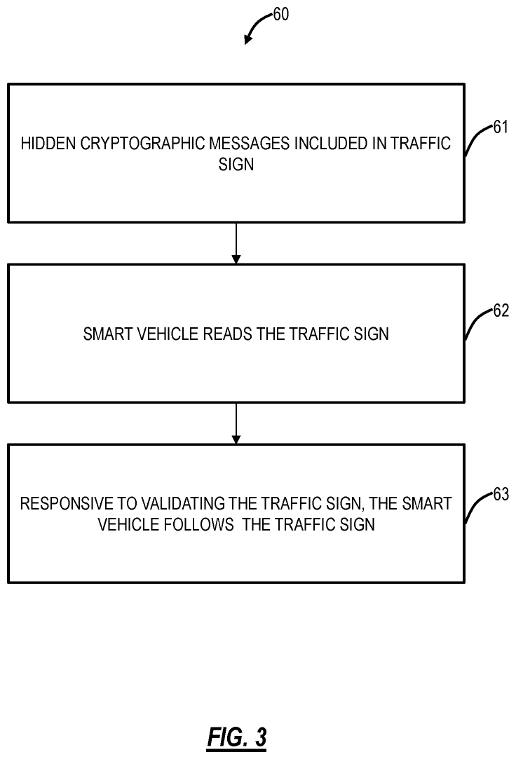

FIG. 3 is a flowchart of a deep fake detection process 60 for identifying fake traffic signs by smart vehicles. Again, those skilled in the art will appreciate the steps in the deep fake detection process 60 may occur at different places, systems, processors, etc., and that the claims herein may be written from a single system perspective. That is, the description of the deep fake detection process 60 in FIG. 3 is a process flow, end to end, including steps performed at different locations. Also, the deep fake detection process 60 contemplates implementation with the deep fake detection system 10, the vehicle 24, and the like. It is important to note while the vast majority of the traffic signs 18 may be valid, it is imperative that any false traffic sign be detected, for safety reasons.

The deep fake detection process 60 includes having hidden cryptographic messages 61 included in traffic signs. That is, the present disclosure contemplates utilizing object stenography or Quick Response (QR) codes in order to validate the authenticity of traffic signs. An autonomous vehicle 62 equipped with a camera is capable of reading these authentic traffic signs and can follow authentic signs 63 while ignoring any other traffic sign where it is not cryptographically signed. The certificate used for this process could hold information such as the coordination of the traffic sign, the issuing authority, and other valuable data that assist with making the sign unique.

Fake News Detection

Fake news (content) could be combatted by securely signing images and providing meta about the image in order to prevent people from misrepresenting a valid image. The objective is to treat and view content like web pages, i.e., HTTP vs. HTTPS. That is, an HTTPS site is more trustworthy than an HTTP site. For example, we know a site with HTTPS is inherently more secure than one with HTTP. The present disclosure proposes various approaches with various content to add this distinction. Another example is code signing which is the process of applying a digital signature to a software binary or file. Advantageously, this digital signature validates the identity of the software author and/or publisher and verifies that the file has not been altered or tampered with since it was signed. Code signing is an indicator to the software recipient that the code can be trusted, and it plays a pivotal role in combating malicious attempts to compromise systems or data. Use cases for code signing can include, for example, software for internal or external use, patches or fixes, testing, Internet of Things (IoT) device product development, computing environments, and mobile apps.

Content Publisher Signing Flow

Similar to code signing, the present disclosure contemplates an initial step of content signing. This can be the first step in the process flow above, namely processing, formatting, and/or embedding data in the content 12, 14, 16, 18, by the deep fake detection system 10, via content publisher signing.

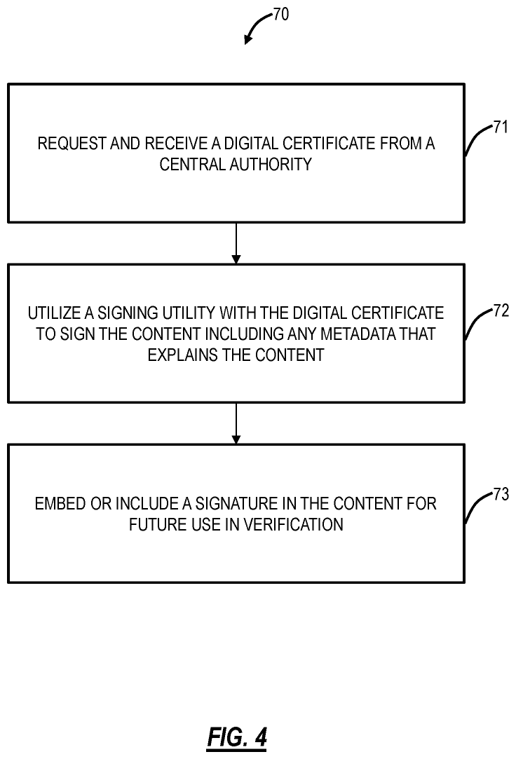

FIG. 4 is a flowchart of a content publisher signing process 70. The content publisher signing process 70 focuses on the first step in the process flow above. The content publisher signing process 70 contemplates implementation as a method having steps, via a processing device configured to implement the steps, via a cloud service configured to implement the steps, and via a non-transitory computer-readable medium storing instructions that, when executed, cause one or more processors to execute the steps. The content publisher signing process 70 also contemplates implementation via a signing utility service or application that behaves much like a code signing utility where a publisher could sign their own content 12, 14, 16, 18 including metadata about that content 12, 14, 16, 18. The content publisher signing process is described herein with reference to steps performed by a content publisher, i.e., any entity responsible for creating the content 12, 14, 16, 18.

The content publisher signing process 70 includes requesting and receiving a digital certificate from a central authority (step 71). This can be a private key and the content publisher can store this digital certificate securely, such as in a Hardware Security Module (HSM), etc. Here, the central authority would verify the content publisher and use an intermediate content signing certificate to issue a new certificate to the content publisher. The content publisher utilizes a signing utility with the digital certificate to sign the content 12, 14, 16, 18, including any metadata that explain the content 12, 14, 16, 18 or the context thereof (step 72). For example, the metadata can include a title, caption, date, location, author, and the like. Next, the signature from the signing utility is embedded or included in the content 12, 14, 16, 18 for future use in verification (step 73).

Signing Utility

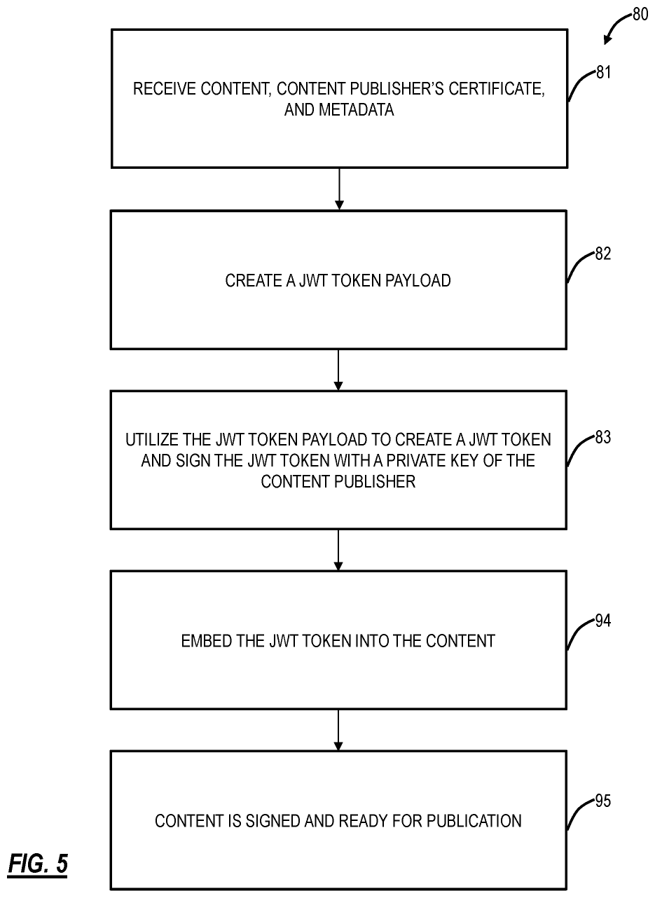

In an embodiment, the signing utility utilizes JWT tokens to securely store the relevant information and uses Least Significant Bit (LSB) steganography to embed the JWT token in the content 12, 14, 16, 18. Other approaches are also contemplated. FIG. 5 is a flowchart of a signing utility process 80. The signing utility process 80 contemplates implementation as a method having steps, via a processing device configured to implement the steps, via a cloud service configured to implement the steps, and via a non-transitory computer-readable medium storing instructions that, when executed, cause one or more processors to execute the steps.

The signing utility process 80 includes receiving the content 12, 14, 16, 18, the content publisher's certificate, and metadata (step 81). The signing utility process 80 creates a JWT token payload (step 82). The JWT token payload can contain the metadata, the certificate, a hash such as with the most significant bits of the content, etc. The hash can be calculated as follows, assuming the content 12, 14, 16, 18 is an image. The image can be first turned into an array of 8-bit unsigned integers representing subpixels with the values 0-255, each sub pixel value is shifted once to the right, the entire array is hashed with SHA-256, and the resulting hash is then stored in the payload.

Next, the signing utility process 80 utilizes the JWT token payload to create a JWT token and signs the JWT token with the private key of the content publisher (step 83). The signing utility process 80 includes embedding the signed JWT token into the content (step 84), such as using LSB steganography. In an embodiment of the LSB, the first 32 bytes, (32 subpixels), are used to encode the length of the message—a message with x characters will be converted to 8-bit numbers with a total of 8*x bits with a message length of 8*x being encoded into the least significant bits of the first 32 bytes of the image. This means that the original value of the first 32 subpixels (11 full pixels) can be modified by ±1 because the least significant bits now contain the information about the length instead of their original values. After the first 32 bytes of the image (subpixels), the next 8*x (x being the number of characters in the message) bytes of the image are used to store the message in their respective least significant bits. The first 32+8*x subpixels have now been modified and no longer hold the information about color but instead hold the information of the embedded message. This changes the image in a very unnoticeable way because each subpixel has only changed by 1 or even possibly stayed the same. Of course, other approaches are also contemplated. The content is now signed and ready to be published and then verified by end users (step 85).

Verification

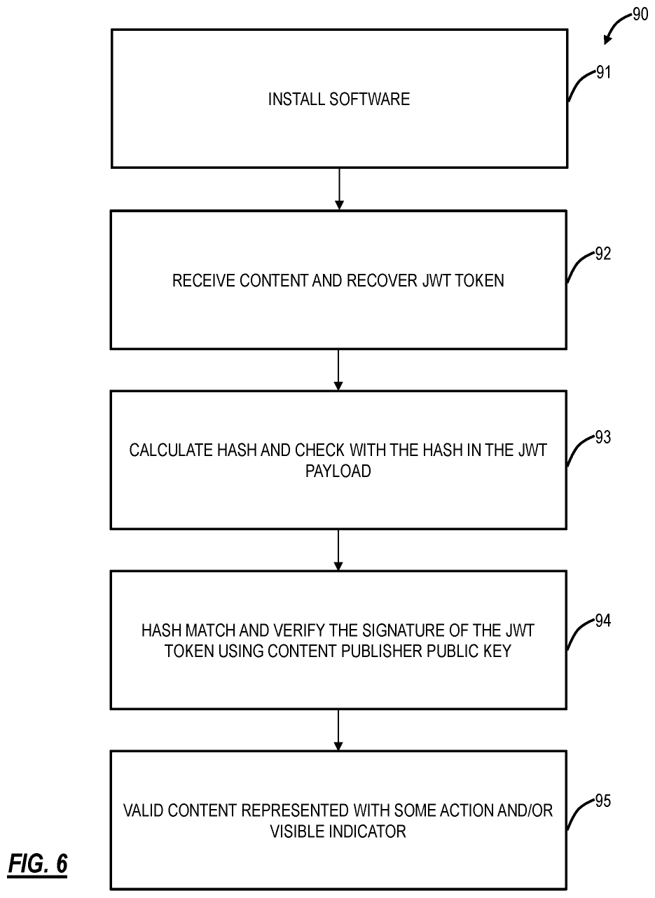

Once the content 12, 14, 16, 18 is signed, the smart television 20, the user device 22, and/or the vehicle 24 needs to verify the content 12, 14, 16, 18. FIG. 6 is a flowchart of a verification process 90 implemented by the smart television 20, the user device 22, and/or the vehicle 24. The verification process 90 contemplates implementation as a method having steps, via a processing device configured to implement the steps, via a cloud service configured to implement the steps, and via a non-transitory computer-readable medium storing instructions that, when executed, cause one or more processors to execute the steps. For illustration purposes, the verification process 90 is described with reference to the user device 22, and specifically to a browser (e.g., Chrome) extension. Those skilled in the art will recognize other software implementations are contemplated with the verification process 90 presented for illustration purposes.

The verification process 90 includes installing software (step 91). This can include a browser extension on the user device 22, over-the-air download in a vehicle 24, and the like. Of course, the devices 20, 22, 24 can be preloaded with the software. Again, in an embodiment, the software is a browser extension. Once installed, the software is configured to verify the content 12, 14, 16, 18, e.g., a Chrome extension could be used to verify images and display the metadata such as via a pop over icon or other ways in the future.

The verification process 90 includes receiving the content 12, 14, 16, 18 and recovering the JWT token (step 92). For example, the software can use LSB to get the JWT token. In an embodiment, as described above, the first 32 bytes, (32 subpixels), are used to encode the length of the message—the least significant bit (the right most bit) is inspected and copied to create a 32 bit number which has a max of 4294967296. Using the length, x, taking the least significant bit from the next x bytes in the image, the message is now a x length array of bits. The x length array of bits is then converted to an array of 8-bit numbers (0-255). The x/8 length array of numbers from 0-255 are then converted to UTF-8 characters, and the message (JWT Token) has now been recovered. Inside the JWT token, the payload is now visible, and the payload data contains the certificates, metadata, and the Most Significant Bit (MSB) hash of the content. The MSB hash is the key to tightly coupling the JWT token to the correct content.

The software then calculates its own MSB hash and checks to make sure it matches with the MSB hash in the JWT payload (step 93). if the hashes do not match, then the content has been modified and is not “Secure.” Assuming the hashes matched, the certificates are then validated using chain validation, and once the final publisher certificate is validated then the public key is used to verify the signature of the JWT token itself (step 94). Valid content can be represented by some action and/or visible indicator. For example, visible content on the smart television 20 or user device 22 can include some flag or other visible means to convey the legitimacy. The action can be blocking the content or allowing the content once a user clicks on an acknowledgement. For the vehicle 24, the action can be at least ignoring the traffic sign 18.

Intelligent Non-Copyable Smart Seal

Seals, or Trust Seals, on-line to date contain only static or linked information. In an embodiment, the present disclosure expands this to have conditional and dynamic capabilities to the traditional site seal where each seal is unique for a short period of time such as via its QR capability, thus making it impossible to copy the seal and presenting it at a different website. The conditional aspect could display identity or security information where it has been previously validated via validation agents. The site seal could dynamically alter and change upon changes of data. In one embodiment, this new process will display a trust seal combined with a dynamic QR code on achieving a defined set of attributes related to site security or identity. This site seal contemplates implementation with any of the content 12, 14, 16, 18.

Recognizing “trust” and “identity” online is confusing and website or visual interface viewers often find it confusing to know what is safe, what is not. For example, typical browsers today only show the negative, when they (the browser companies) decide that something is ‘bad’, and they reject connecting. A more positive experience is when we have more information, in a way that is easy to consume, simple to recognize, and not repeatable for invalid websites. In other words, the current trust seal indicators are easily repeatable via screen capture or a simple search on the internet which essentially allows malicious websites to also have a trust indication.

The visibility of the logo of the site your visiting, appearing in a 3rd party verification (in this case the seal), provides positive validation that a set of security and identity challenges have been met, thereby improving comprehension of the safety and security efforts invested by the site provider. The display of additional identity and security information to the content 12, 14, 16, 18 you are viewing including all the checks performed or analysis of the domain, organization, and company to help the Internet user determine if the site is trustworthy and safe to use.

In an embodiment, the QR functionality (Quick Response) allows the user to either use a browser plugin or the camera on their smart phone to validate the seal authenticity at any point, essentially increasing the overall trust that users can have while interacting with content 12, 14, 16, 18.

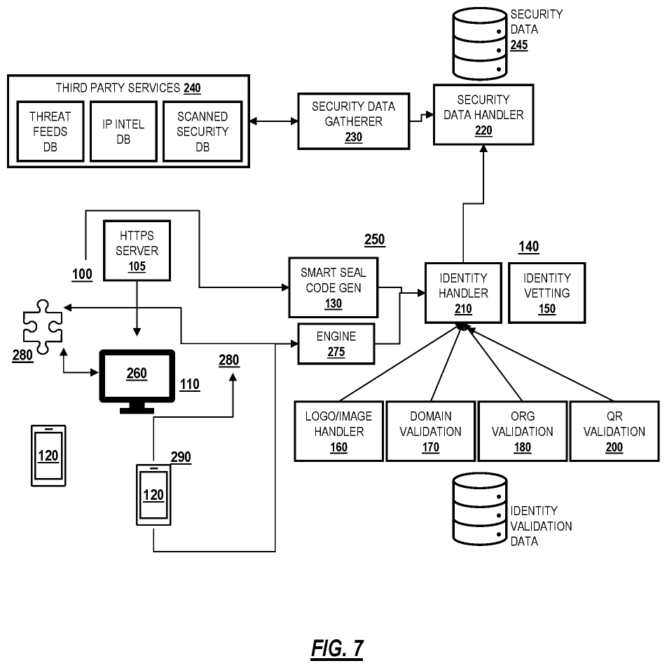

FIG. 7 is a network diagram of example systems and process flow for a conditional smart seal for the content 12, 14, 16, 18. Of course, those skilled in the art will appreciate other implementations are also contemplated. As described herein, a site seal can be something embedded in or included with the content 12, 14, 16, 18 for purposes of conveying its legitimacy. The following description is for a site seal for a website, but those skilled in the art will recognize this can be applied to any of the content 12, 14, 16, 18.

A site seal is traditionally used to list that a website uses a particular certificate authority or could be used to state that they have had some identity or other capabilities that have passed checks and vetting with a company. In an embodiment, the approach described herein seeks to solve the issue with the traditional site seals where copying the seal via methods such as screenshot was easy and essentially it was reducing the authenticity of the seal via placing it on an unverified website.

In an embodiment and with reference to FIG. 7, starting at 100 you see a website administration (content publisher) who would like to display a smart seal on their website. The website admin has a web server 105 which the smart seal code will be deployed. The smart seal will be displayed on a web browser website 110. There can be the seal at the bottom right corner of the website. This is more than an image and could be located within any point of the webpage. An Internet user 120 who is browsing to the web server URL address and when the HTML page is generated, it will also load up the site seal code to display which the website admin 100 placed on the web server 105. The Internet user 120 will interact with the smart seal via either a browser plugin 280 which previously has been installed or via a camera 290 on their smart phone capable of scanning a QR code.

To get the smart seal code, the website admin 100 will need to come to a certificate authority and request the smart seal code. The website admin requests the smart seal code generator 130. A validation agent 140 performs the identity vetting for the website identity 150. The identity vetting could be performed at the time the website admin 100 requests the smart seal 130 or it could be pre-vetted. This does not have to be dynamic at the time but could be performed hours, days, months ahead of time. The identity vetting 130 could also be identity vetting done typical of a public trusted certificate authority or could be just in time as the website admin requests it.

Identity vetting could include the following types of information—(1) Logo/Image/Trademark, (2) Domain, (3) Organization, and (4) Other possible identity data. A logo/image could be a trademarked image or could be a vetted information from other sources. The validation agent at 140 could perform vetting from the associated countries trademark database or could be vetted logo information from something like the industry standard BIMI (Brand Indicators for Message Identification) or from numerous other ways to vet a logo to be used to display within a smart seal. In practice you would want some type of vetting to be performed on the logo/image to be inserted within the smart seal but in reality, it does not necessarily have to be vetted.

A Logo/Image handler 160 can gather the vetted logo or image that is stored within an identity validation database. Domain Validation 170 is the domain URL data and the vetted data that is performed in a typical publicly trusted Transport Layer Security (TLS) certificate. Organization Validation data 180 for the organization identity information is vetted data associated with the domain. This is also known to the art and is typical for a publicly trusted TLS certificate. There could be additional Identity data that could be used, which could be information such as individual identity, country specific identity information, or other possible identity data. A QR validation function 200 is capable of validating the authenticity of QR codes issued to each unique website. Each of these identity information is used within the smart seal 110 which is displayed to the Internet User 120.

An Identity Handler 210 gathers all the associated identity information that could be used/displayed within the smart seal. The Identity Handler 210 could also request additional security information from a Security Data Handler 245. The Security Data Handler 245 could use various identity information gathered by the Identity Handler 210. For example, a domain could be used to gather security information regarding that domain. An organization name could be used to gather security data regarding that organization. Other identity information could be used to gather security data.

Additionally, at 230 there is a Security Data Gatherer, this gathers security data from other 3^{rd} party data sources, or it could be data sources within the company. Examples of data sources are at 240 which could include threat feed databases, IP intelligence databases, scanned security databases, or any number of other possible security data sources. The Security Data Gatherer 230 also has a timer to perform regular re-gathers of the data sources. All of the data is stored within a security data database 245 and stored in a fashion where historical information can be display either via the smart seal at 110 or could be utilized for conditional display changes or risk changes of the domain in question.

Now all the identity and security data has been gathered the smart seal generator 130 can create the smart seal code 250. The smart seal code can also include a timer which would cause a dynamic code refresh which would modify the smart seal as it's vended to the browser. The website admin 100 can now place the customized smart seal code on the web server 105. You can see the smart seal code at 260.

Now that the smart seal code is on the website. The Internet User 120 will open the domain URL which causes the webserver to vend the HTML content including the smart seal code to the browser 260. You can see an example of a smart seal at 110. The smart seal code is intelligent code that updates either naturally with a timer or it could update based off of gathering new data and information directly from the smart seal engine at 275. The QR on 110 is also derived based on a timer where every so frequently a new QR code will be generated. This guarantees that no attacker can copy the seal and place it on their websites since either browser plugin 280 or smartphone camera 290 will validate the QR code. When the smart seal code is executed on the browser, gathering date from the smart seal engine 275, the seal itself will modify based off the content. The smart seal starts at 280 with a logo depicting some indication of security, then upon a hover/set time/or other possible variables it will change to display information at 290. This information could include identity information or security information or both. All of this could cycle numerous times with numerous various images or data depicting identity or security information. The Internet User 120 now has a method to trust the domain that he/she has gone to. The Internet User can see various identity or security information including a logo that they might regular see noting that this is a trustworthy site with additional points of validation to increase its trust worthiness.

Processing System

FIG. 8 is a block diagram of a processing system 300, which may implement any of the devices described herein. The processing system 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 8 depicts the processing system 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example, but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a Central Processing Unit (CPU), an auxiliary processor among several processors associated with the processing system 300, a semiconductor-based microprocessor (in the form of a microchip or chipset), or generally any device for executing software instructions. When the processing system 300 is in operation, the processor 302 is configured to execute software stored within the memory 310, to communicate data to and from the memory 310, and to generally control operations of the processing system 300 pursuant to the software instructions. The I/O interfaces 304 may be used to receive user input from and/or for providing system output to one or more devices or components.

The network interface 306 may be used to enable the processing system 300 to communicate on a network, such as the Internet. The network interface 306 may include, for example, an Ethernet card or adapter or a Wireless Local Area Network (WLAN) card or adapter. The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 308 may incorporate electronic, magnetic, optical, and/or other types of storage media. In one example, the data store 308 may be located internal to the processing system 300, such as, for example, an internal hard drive connected to the local interface 312 in the processing system 300. Additionally, in another embodiment, the data store 308 may be located external to the processing system 300 such as, for example, an external hard drive connected to the I/O interfaces 304 (e.g., SCSI or USB connection). In a further embodiment, the data store 308 may be connected to the processing system 300 through a network, such as, for example, a network-attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 may include one or more software programs, each of which includes an ordered listing of executable instructions for implementing logical functions. The software in the memory 310 includes a suitable Operating System (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

Of note, the general architecture of the processing system 300 can define any device described herein. However, the processing system 300 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

Process of Identifying Deep Fake Content

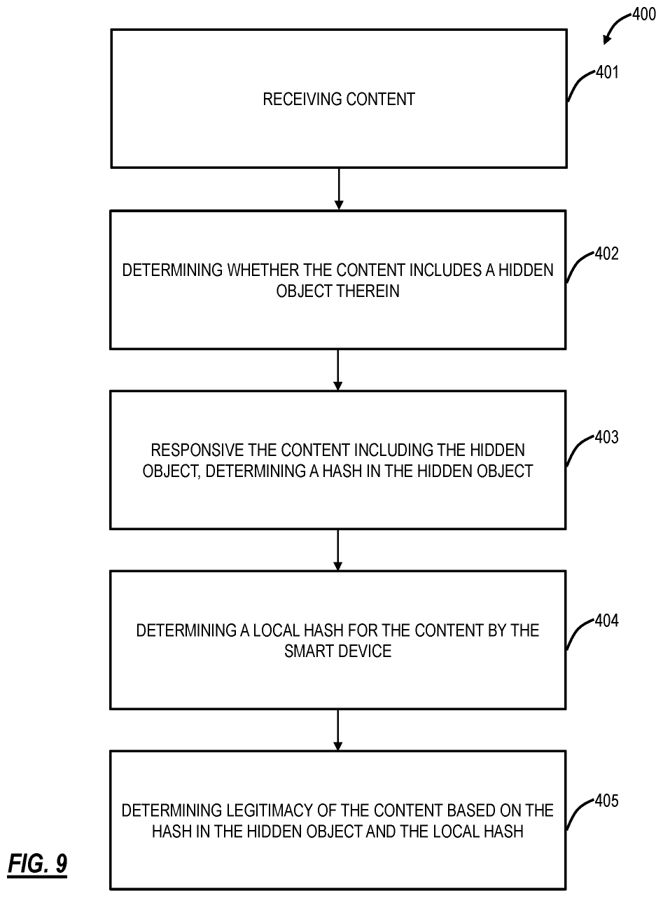

FIG. 9 is a flowchart of a process 400 of identifying deep fake content. The process 400 contemplates implementation as a method having steps, via a processing device in a smart device configured to implement the steps, and via a non-transitory computer-readable medium storing instructions that, when executed, cause one or more processors to execute the steps.

The process 400 includes receiving content at a smart device (step 401); determining whether the content includes a hidden object therein (step 402); responsive the content including the hidden object, determining a hash in the hidden object (step 403); determining a local hash for the content by the smart device (step 404); and determining legitimacy of the content based on the hash in the hidden object and the local hash (step 405).

The hidden object can be a JavaScript Object Notation (JSON) Web Token (JWT). The JWT can be embedded in the content using Least Significant Bit (LSB) steganography. The smart device can be a smart television and the content is video. The process 400 can further include determining the legitimacy by verifying a signature of the hidden object with a public key. The process 400 can further include, prior to the receiving, creating the hidden object using certificates from entities involved with creation of the content. The process 400 can further include, subsequent to the determining legitimacy, providing a visible indication on the smart device. Note, in some embodiments, the content may not include the hidden object, in which case the visible indication can be omitted.

Identifying Deep Fake Video by Comparing with Authentic Video

Additional embodiments are described in the present disclosure for detecting deep fake video content, particularly video content of a prominent individual such as a politician, actor, singer, etc., or any predetermined individual. With respect to the embodiments described below, the detection of deep fake content includes a process where a genuine video is produced of the known individual in a controlled setting (e.g., location such as a studio, predetermined poses, verbiage, facial movements, etc.). The genuine video can be used to train a machine learning model for generating new content. Then, any questionable or dubious video that is obtained from the Internet can be compared with the new content generated by the genuine video to detect certain nuances of speech and body movements. In this way, if a deep fake video does not include the same or similar voice characteristics and body movements as the real thing, then the dubious video can be tagged as fake. Also, if a video appears to match up with the genuine video (at least to a certain degree), then the video can be tagged as real.

The deep fake detection systems and methods described above may be used in this context in which questionable video can be investigated to determine its validity. Upon determining whether a video is real or fake, the systems and methods of the present disclosure may further include embedding an easily viewable and/or a hidden or concealed image in the video to indicate if the video is real or fake. In some embodiments, the application of a visible or hidden object may include a watermarking process. Also, the systems may further apply a watermark to training data of a high-definition video obtained from the controlled setting of the prominent individual to indicate that the controlled video is genuine. In some embodiments, a certificate can be issued for the high-definition video to affirm that the video is actually a real video of the prominent individual.

Conventionally, a person trying to deceive viewers can attempt to make a convincing deep fake video. They might get as much available content as possible and then train a model which is then used to create the deep fake. For example, in a recent news story, a deep fake video of Tom Hanks was used to create an advertisement that Tom Hanks did not actually endorse.

To counteract such attempts at creating deep fake video, the systems and methods of the present disclosure can obtain training data directly from a source (e.g., a prominent person, predetermined person), create a model from this training data, and then use the model to detect whether or not other videos of the same source are real or a deep fake. For example, a prominent person (e.g., Tom Hanks) would sit in front of the camera and follow instructions so that authentic training data could be created. Of note, while described as a prominent individual, those skilled in the art will appreciate this can be any predetermined individual, i.e., one providing authentic training data for the purposes of detecting future deep fake videos.

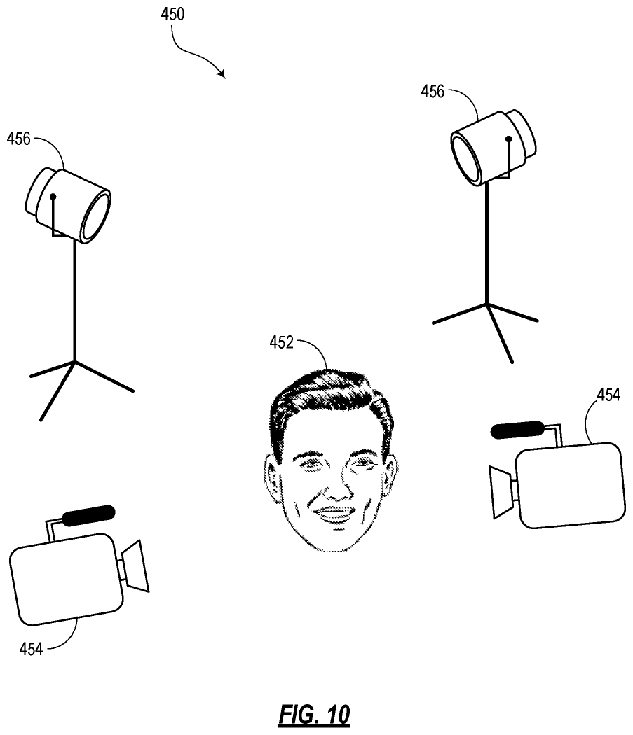

FIG. 10 is a diagram illustrating an embodiment of a controlled setting 450, such as a studio, for obtaining a high-definition video of a prominent individual 452. For example, the controlled setting 450 may include one or more cameras 454 configured to capture audio and video of the prominent individual 452 from one or more angles. The controlled setting 450 may also include one or more lights 456 to allow the one or more cameras 454 to obtain high-resolution images. The audio and video data can be stored in a suitable memory or database and then analyzed to detect correlations between the words and sounds that the prominent individual 452 speaks and the way they his or her face, mouth, etc. move while speaking. According to various examples, the prominent individual 452 may be a celebrity, a famous person, a luminary, someone in the public eye, someone in the limelight, an actor, an actress, a musician, a politician, an influencer, and/or anyone who is important, well-known, famous, frequently “in the public eye,” “in the limelight,” “in the spotlight,” etc. That is, the prominent individual 452 is one who might have a deep fake made against them. Again, this could be any predetermined individual.

Also, the controlled setting 450 can use a mobile device as well for the camera 454. That is, conventional mobile devices have high-definition cameras for video and audio. The controlled setting 450 can be more than the lighting, location, etc., but can include poses, recitation of known phrases, facial movements, etc.

In the controlled setting 450, it is possible to get so-called “golden data” that can be perfect for training a model since it is taken directly from the source (e.g., the prominent individual 452) of the audio and video. As such, since this may be a service to the prominent individual 452 to protect their image, the prominent individual 452 (e.g., Tom Hanks) may wish to participate in this exercise to prevent unwanted deep fake videos from appearing on the Internet. After creation of a model derived from genuine training data, any dubious video that appears on the Internet can be scrutinized by the systems described herein to determine if the dubious video was created using. Of course, most prominent people clearly would not want AI creations or deep fake video content to circulate on the Internet without their permission or consent.

To obtain reliable data, certain procedures may be performed to prompt the prominent individual 452 in a number of ways, perhaps similar to a lie detector test where the prominent individual 452 is asked multiple questions to try to invoke certain emotions. For example, the prominent individual 452 may be prompted to read a script in different emotional states (e.g., when calm, when agitated, when tired, etc.). They might answer a number of questions, tell a story, tell a joke, describe something they like, describe something they dislike, scream, sing, laugh, smile, frown, etc. Audio and video data can be obtained simultaneously to detect how their face, mouth, lips, etc. move while speaking certain words or sounds. Also, head, shoulder, arm, and hand movements can also be observed and correlated with speech to determine how the prominent individual 452 uses body language while speaking, particular under different emotional states. In this way, a rich set of data can be obtained that accurately defines the audio and video characteristics of the person.

When the genuine video is obtained using the controlled setting 450, the systems and methods of the present disclosure may be configured to watermark the data and encrypt the data. It would be important to safeguard this data, especially since the data obtained in this manner, if it fell into the wrong hands, could then be used to create more realistic and deceptive deep fakes. With the authentic training data, the systems herein can train a model to create deep fakes, if permitted by the prominent person, and also use the model to compare a given questionable video to determine whether it is real or not.

Training a Reliable Model

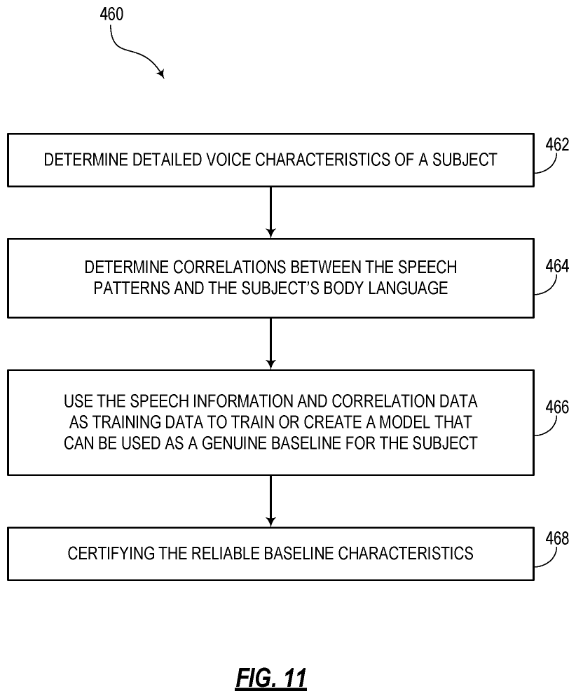

FIG. 11 is a flow diagram illustrating an embodiment of a method 460 for training a deep fake detection model. After the capturing of the genuine video data, such as by using the controlled setting 450, the systems and methods of the present disclosure may include using the reliable data (e.g., golden data) to create a model that can be used for comparison with other videos to determine if they are real or fake. The method 460 is configured to train such a model. The method 460 may be implemented in any suitable combination of hardware, software, firmware, etc. in the processing system 300. For example, the method 460 may be stored as computer code or program 316 in a non-transitory computer-readable medium (e.g., memory 310) and executed by the processor 302 or one or more other processing devices.

The method 460 may include, for example, the step of determining detailed voice characteristics of a subject (e.g., the prominent individual 452), as indicated in block 462. The voice characteristics may include pronunciation, enunciation, intonation, volume, articulation, pauses, pitch, rate, rhythm, clarity, etc. of the subject's speech patterns. Also, the method 460 may include determining correlations between the speech patterns and the subject's body language, as indicated in block 464. In particular, the body language may simply be the movement of the muscles in the face and mouth while speaking and how the skin moves. The video data may also include detection of veins, muscles, fat, and skin. Skin detection may include analysis of the characteristics of wrinkles, hypodermis, dermis, epidermis, subcutaneous tissue, etc.

The method 460 further includes the step of using the speech information and correlation data (i.e., matching the speech with bodily movements) as training data to train or create a model that can be used as a genuine baseline for the subject, as indicated in block 466. The training may include Artificial Intelligence (AI), Machine Learning (ML), Reinforcement Learning (RL), and/or other algorithms, techniques, methods, etc. for defining an accurate and real depiction of the subject's speech and bodily movements. Next, the method 460 includes the step of certifying the reliable, genuine, authentic baseline characteristics, as indicated in block 468. The certification step (block 468) may include submitting a Certificate Signing Request (CSR) to a Certificate Authority (CA) and obtaining a digital certificate from the CA authenticating the baseline data as genuine or authentic.

Method for Identifying Deep Fake Videos

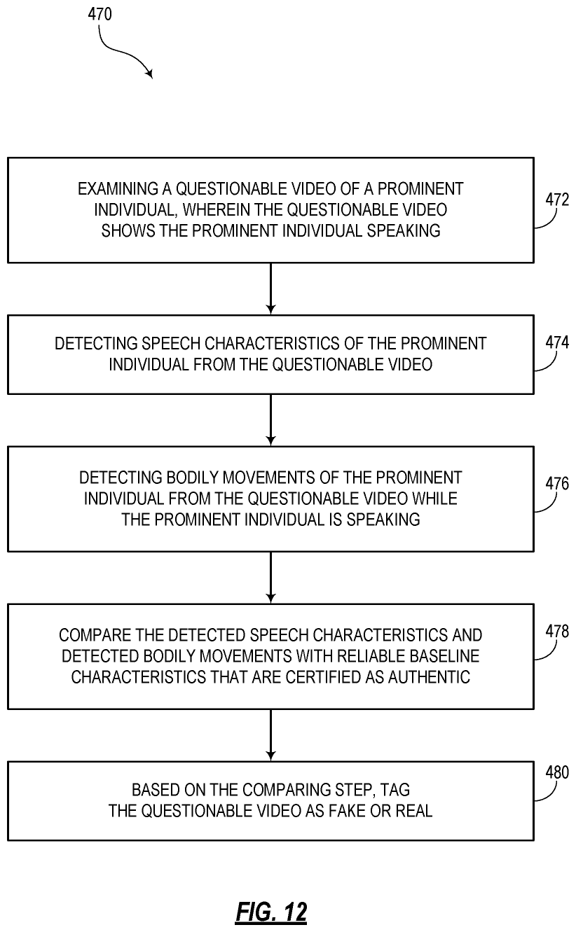

FIG. 12 is a flow diagram illustrating an embodiment of a method 470 for identifying deep fake videos or other artificially created videos, particularly videos of a prominent person speaking. As shown in FIG. 12, the method 470 includes the step of examining a questionable video of a prominent individual (e.g., prominent individual 452), wherein the questionable video shows the prominent individual speaking, as indicated in block 472. Next, the method 470 includes detecting speech characteristics of the prominent individual from the questionable video (block 474) and detecting bodily movements of the prominent individual from the questionable video while the prominent individual is speaking (block 476). The method 470 further includes comparing the detected speech characteristics and detected bodily movements with reliable baseline characteristics that are certified as authentic, as indicated in block 478. Then, based on the comparing step (block 478), the method 470 includes the step of tagging the questionable video as fake or real, as indicated in block 480.

According to some embodiments of the method 470, the reliable baseline characteristics may include authentic speech characteristics and authentic bodily movements derived from a high-resolution video recording of the prominent individual in a controlled setting (e.g., controlled setting 450). For example, the authentic speech characteristics may include high-resolution voice parameters defining how specific phonemes, words, phrases, and/or sentences are spoken by the prominent individual. The authentic bodily movements may include movements of one or more of mouth, face, eyes, eyebrows, head, shoulders, arms, hands, fingers, and chest when the specific phonemes, words, phrases, and/or sentences are spoken by the prominent individual.

Furthermore, the authentic speech characteristics may include parameters related to one or more of pronunciation, enunciation, intonation, articulation, volume, pauses, pitch, rate, rhythm, clarity, intensity, timbre, overtones, resonance, breaths, throat clearing, coughs, and regularity of filler sounds and phrases, such as “urn,” “uh,” “you know,” “so,” etc. Also, the high-resolution video recording may be created while the prominent individual is performing one or more actions selected from the group consisting of a) reading a script, b) reading a script multiple times within a range of different emotions, c) answering questions, d) answering questions multiple times within a range of different emotions, e) responding to prompts, f) telling a story, g) telling a joke, h) describing something the prominent individual likes, i) describing something the prominent individual dislikes, j) laughing, k) singing, l) smiling, and m) frowning. The method 470 may further include the step of creating a digital certificate of the high-resolution video recording to certify the high-resolution video recording as authentic (e.g., block 468 shown in FIG. 11).

In addition, the method 470, according to some embodiments, may further include the step of detecting parallel correlations between the authentic speech characteristics and the authentic bodily movements, and then using the parallel correlations as training data to create a model defining the reliable baseline characteristics. Also, the method 470 may further include the step of determining a percentage of accuracy of the detected speech characteristics and detected bodily movements with respect to the reliable baseline characteristics. For example, when the percentage of accuracy is below a predetermined threshold, the questionable video can be tagged as fake, and, when the percentage of accuracy is above the predetermined threshold, the questionable video can be tagged as real. Tagging the questionable video as fake or real may include applying one or more visible and/or hidden watermarks.

The present disclosure describes systems and methods for detecting fake videos (e.g., deep fake videos) of famous people and are configured to address a well-felt need in society to know whether sources of information are real or fake and to know what is true and what is fabricated. As an example, a recent issue in this regard revealed a deep fake video of Ukrainian President Volodymyr Zelenskyy, which went viral. For example, generative AI can be used in many cases to generate content like videos and art that is actually deep fakes. Unfortunately, many of these fabricated or generated content can be very difficult to distinguish from real videos of a person. Therefore, the systems and methods described above can provide a high level of authenticity verification for the generative content, like videos and art. In particular, a solution in this respect may involve using available digital trust platforms and methods to hash and digitally sign the content created by the authorities (e.g., CA) before releasing it to the public. The procedure of applying a certifiable verification that can be built in the video can allow viewers to see such a verification of the authenticity of any questionable video. Thus, the systems may show a tick mark, watermark, and/or any sign to show the origination of the content. In this way, the systems can actually hinder the distribution of deep fake content and thereby apply culpability of harmful deep fake to the people attempting to deceive an audience. Hence, the present disclosure may thwart efforts by malicious people to impersonate prominent individuals in a way that can be disparaging to the individual or that can be harmful to the public.

Therefore, the present disclosure described systems and methods for verifying the authenticity of digital content to distinguish between real videos and fake or generated videos (e.g., deep fake videos, generative AI, etc.). The systems and methods may use certificates to identify the original content using hash functions and digital signing of original video content to distinguish real videos from derived videos. Some methods may include feature extraction methodology for extracting eye features and then inputting these eye features to a long-term model, such as by using a Recurrent Neural Network (RNN), a Convolutional Neural Network (CNN), and/or a Recurrent Convolutional Neural Network (RCNN).

The present disclosure proposes systems and methods for identifying the deepfakes using any models correlating audio and video components of an individual's speech and body movement. This may also include an advanced breath analysis to detect how the individual breaths while talking and includes multiple biological identification techniques to tag an unknown or dubious video as either fake (e.g., deep fake) or real.

Of course, there is already a lot of content available in the form of videos and images. The systems and methods can be used to analyze this content with respect to the high-resolution audio and video data obtained from the actual source. However, in some embodiments, it may be a more worthwhile pursuit to start the authentication process for new videos and even video recording equipment that can be adapted to the new methods described herein. Therefore, instead of processing video content from a source library (e.g., YouTube, Vine, or other video streaming platforms) using multiple methods to tag the source and originality of video, the present systems may be configured to provide a solution for the identification of generated videos, graphics videos, and original videos.

The programs 316 shown in FIG. 8 may further include video processing functionality and computer logic to accomplish the video validation processes described herein. The video processing programs can behave like a judging system for judging, analyzing, or inspecting a video and tagging it using a watermark that indicates whether the source of the video is legitimate. The video processing systems and methods may have two or three subsystems which could handle multiple identification mechanisms.

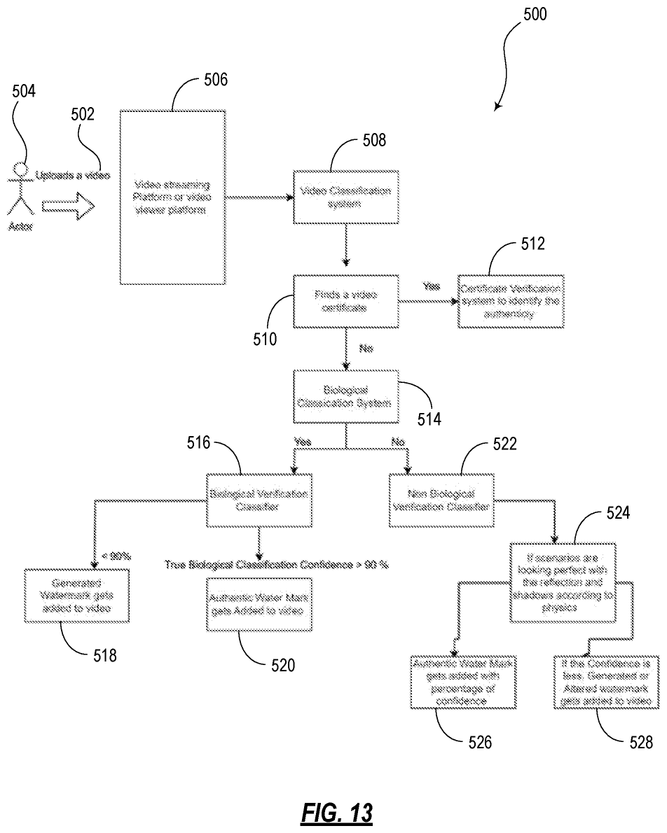

FIG. 13 is a block diagram illustrating an embodiment of a judging system 500. A video 502 of an actor 504 or other prominent individual is uploaded to a video streaming platform 506 or video viewer platform. The video streaming platform 506 may be configured to test the video 502 to analyze various aspects of the video 502, such as whether the video 502 is real or fake, whether the video 502 includes a certificate of authenticity, biological classification, non-biological classification, etc.

The judging system 500 may initially analyze the video 502 using a video classification system 508 to determine its type. That is, the video 502 may be classified based on the predominate subject in the video 502. For instance, the video 502 may be classified as being directed to one or more humans, one or more animals, interactions between one or more humans and one or more animals, natural occurrences, phenomena, events, etc. (e.g., lightning, floods, tidal waves, etc.), and actions or events (e.g., car accidents, disasters, explosions, etc.). Next, the judging system 500 may include a module 510 related to finding a certificate for the video 502. If the video 502 includes a certificate, then, the function flow can go to block 512, which indicates that the judging system 500 finds a certificate associated with the video 502 and can therefore identify the video 502 as authentic. However, if the video 502 does not contain a certificate and the validity of the video 502 is therefore unknown, then the judging system 500 may continue with a biological classification system 514.

The video 502 can be forwarded to the biological classification system 514, which may be configured to determine if the video 502 is classified as biological (e.g., human, animal, etc.) or non-biological (e.g., man-made objects, cars, planes, bombs, missiles, explosions, etc.). If it is determined that the video 502 is directed to a biological subject, the functionality of the judging system 500 proceeds to a biological verification classifier 516. The biological verification classifier 516 may include a human component for detecting features of the human in the video 502. For example, the analysis may be the same as or similar to the methods described in FIGS. 11 and 12. The biological verification classifier 516 may be configured to determine a level of confidence that the video 502 is real. For example, this level of confidence may be represented as a percentage based on a comparison of the video 502 under question with high-resolution video data obtained in a controlled environment, such as the controlled setting 450 of FIG. 10.

If the degree or level of confidence is below a predetermined threshold (e.g., 90%), then the flow proceeds to block 518, which includes generating a watermark that is added to the video 502 indicating the video 502 is likely “fake,” “a generated video,” “not authentic,” “AI generated,” or some other similar indication, symbol, marking, etc. (visible or hidden) to allow the user or the user's device to know that the video should not be trusted as authentic but instead should be understood as fake or unreliable. Otherwise, if the biological verification classifier 516 determines that the level or degree of confidence is above the predetermined threshold (e.g., 90%), then the flow proceeds to block 520, which includes generating a watermark that is added to the video 502 indicating the video 502 is likely “real,” “authentic,” “genuine,” “bona fide,” etc. It should be noted that the biological verification classifier may include any number of ranges of confidence. For example, above 95% may be classified as “authentic,” whereas 85% to 95% may be classified as “likely authentic” and below 85% may be classified as “fake.” Of course, other ranges and definitions are contemplated in the present disclosure.

If, with respect to the biological classification system 514, it is determined that the video 502 is non-human (or non-biological), then the judging system 500 may be configured to proceed to the non-biological verification classifier 522 to classify different types of non-biological subjects, such as natural phenomena, man-made objects, etc. Based on this classification, the judging system 500 proceeds to block 524 to determine if the scenes follow natural or physics laws. For example, the video 502 can be investigated with respect to known laws of physics (e.g., gravitational forces, centrifugal forces, shadows, reflections, glare, etc.). Also, the judging system 500 can determine how well or to what degree the video 502 follows these natural or physical laws. If the video 502 has a degree or percentage of confidence above a certain predetermined threshold (e.g., 90%), then the judging system 500 proceeds to block 526 and is configured to apply a watermark indicating that the video is authentic or likely authentic. However, if the video 502 is found to fall short of the predetermined threshold, then the judging system 500 goes to block 528 and is configured to apply another type of watermark for indicating that the video 502 is real or likely real.

An initial processing system could try to find the video certificate for the video, which could be from the original device or the processed system and uses methods similar to SSL verification to verify the certificates. It could also tag the videos as authentic without further processing. If the video does not have any authentication certificates, it will further the processing to the biological classification system 514, which can be a CNN which is trained to identify the biological features in the video like humans, animals, or any leaving objects. Then, the system can route the classification accordingly to the next system, which verifies the biological features of the actors or animals in the video.

The biological verification classifier 516 can consider several items for the verification that may include but is not limited to:
1. Face manipulation as deepfakes normally morph the face,
2. Facial hair and/or hair detection to identify if the hair patterns look natural or fake,
3. Eye detection to identify if the eye looks natural and has a normal number of blinks and light reflection,
4. Breath detection to identify if the person in the video is breathing in a normal or abnormal way,
5. If the veins in the face or neck are pumping and in rhythm to the speech or actions,
6. If the actions of the physiology are smooth or different from the actions of the person in picture, or if he or she is a well-known person and persons physiology data is present with the system,
7. If the spoken word patterns and speed are in accordance with the identified person, and provided the face recognition has pulled a known identity and their data is pulled to system, and
8. And if the facial features look too good to be real, or if the lip sync is in accordance with the language or is it dubbed, etc.

Based on these features, the judging system 500 can tag a video as authentic with the percentage of confidence. Or it can tag as a generated video if it finds it as AI generated or such. If the video contains non-biological content, the scenarios get verified according to the physics and nature of the object. For example, if a blast or accident is present in the system, the physics of the various movements of the objects will be verified to identify if they are accurate. Also, the shadows, reflections, and glare on reflective surfaces will be judged to identify if the objects and scenarios are real in the video and can then be tagged as real or generated with the confidence watermark.

This mechanism can be implemented in large video streaming services. Social media platforms can also make the identification and verification of deep fake videos much easier as it not only gives a new way of identifying videos with certificates, but also generates the certificates and watermarks with respect to the videos with the identified confidence of originality. The watermark can be embedded along with the generated certificate which will stay with the video content. If downloaded, the video can be transferred to multiple devices and will help in verifying the authenticity of the videos.

The systems and methods for verifying whether an unknown video of a human (or prominent person) is real (genuine, authentic) or fake (generated, AI-created) may be implemented in any suitable form, such as embedded as computer code in a non-transitory computer-readable medium, embedded in an Application Programming Interface (API), or other suitable type of implementation. The systems (e.g., processing system 300) may be configured to train a machine learning model based on valid and existing videos and audios of the same individual. This may include a massive amount of data. Again, knowing the source, such as when audio and video data is captured in a controlled setting, the systems can push the data into any suitable type of artificial intelligence classifier. For example, this may generally be AI, because there may be several different algorithms that this may include. The systems can train, for example, based on voice. That is, how does the prominent person pronounce the word “spectacular,” for example. If a dubious video is inspected, the system can compare that specific word, if it exists in the video, with the controlled-environment or reliable genuine video and can determine if the pronunciation of this word is the same, similar, or dissimilar. If it is different than every model that has been obtained using the reliable setup and trained, then the systems can determine with a certain probability or percentage if the voice is real or fake.

An advantage of the embodiments is that the controlled environment allows the systems to capture audio and video in high-definition or high-resolution. Thus, an extremely accurate baseline can be established for this individual. Then, when comparing with a video of unknown origin, someone trying to deceive an audience would not have access to highly accurate data, but instead might rely on faulty reference information. It would therefore be difficult for a faker to attempt to create a deep fake with the same level of accuracy since they would be starting with disjointed and grainy videos that may try to piece together. Thus, when comparing with the original, the concocted video would clearly expose its flaws to the current systems having a high level of preciseness.

The big differentiator here is that, for any adversary, the data that they have available is what they might be able to collect off of YouTube videos or other similar sources, what they can collect from conferences and public speeches, etc., whereas, for the defensive side, which includes the embodiments of the present disclosure, the data that is collected by the present systems is based high quality data from the individual himself. Also, with the proper prompts, the individual can speak certain phrases that are common to the individual. While creating the baseline video in the controlled setting, the individual can provide valuable input for training the model. In some instances, the individual may be prompted to do more than just speak certain words or phrases. For example, the individual may be prompted to raise their arms, clap their hands, salute, put his hands on his hips, jump up and down, make different facial expressions, smile, laugh, cry, or whatever. All of this can be used to contribute to the training. In a sense, the large amount of data can be used to create a large amount of high-quality supervisory learning input data for generating an extremely accurate AI baseline model for comparison with other videos of unknown origin. Also, the controlled environment allows the capture of data that is more valid and has less noise.

There is obviously an incentive for a celebrity, politician, or other famous person to contribute to this endeavor to prevent the deception of fake videos. By providing a training data from a “true source,” as it may be referred to, other videos cannot be copied with the same level of accuracy and any AI generated videos would clearly be detected as fake and would hold up to the source of truth.

Once the systems have collected all of this data from the celebrity, the systems can use a personal digital certificate of the certificate, which may be referred to as “client certificates” or “client certs.” The celebrity could then digitally sign the client certificates to certify that the data is accurate.

Thereafter, it would not be necessary in all cases to go to the celebrity to ask them if a certain video is real or not. The systems and methods of the present disclosure can provide authoritative analysis as to whether a video is real or fake, without the need to ask the celebrity. Instead, it may be possible to look up the certificate that corresponds to this data collected and determine if has a valid certificate. In some embodiments, the systems can give the certificate a specific expiration date, particularly since people change over time. For example, a certificate may be valid for about 12 or 24 months and then, if the person wants to renew it, they can go back and do the video capture in the controlled environment again. Because people age and look different over time and their voice may change by a detectable amount over time, new video baselines may be obtained to create a new set of data, which again can be signed.

Various types of machine learning techniques can be used for training models and/or comparing unknown videos with the baseline data. For example, the AI or ML algorithms may include deep learning algorithms. One example of deep learning is Generative Adversarial Networks (GANs), which is able to generate discriminators that can be used for generating new data and senses, such as images or text. Other AI may include Natural Language Processing (NLP), which basically means that whatever is spoken can be written out and formatted. Another example is Reinforcement Learning (RL), which basically means that an individual can sit down in front of a camera, look at video and audio components, and specifically instruct to tag the specific content as a baseline classifier for the individual that can later be used for comparisons.

Process for Watermarking Machine Learning Training Data for Verification Thereof

As mentioned above, watermarks may be applied to videos for tagging the videos as real or fake or for marking the video with a percentage or degree of confidence in the legitimacy of the video. In some cases, there may be multiple levels of authenticity confidence marked on the video, such as “clearly authentic,” “possibly authentic,” “likely fake,” “clearly fake,” etc. In some embodiments, an authentic video can be marked with a check mark, a thumbs up, or other symbol on the video. This could be placed in a header of the video, in a footer, superimposed on top of the video, etc. In some cases, the watermark may include the word “verified” or “authentic” or some other word to define the video as real.

The systems may include watermarking machine learning training data for verification thereof. The processes may describe both ends of the watermarking, namely the initial creation stage by the training data provider and the subsequent verification stage by the machine learning model provider using the watermarked training data. The process contemplates implementation as a method having steps, via a processing device or the cloud having computing resources with processors configured to implement the steps, and as a non-transitory computer-readable medium storing instructions that, when executed, cause one or more processors to implement the steps.

As is known in the art, digital watermarking, or simply watermarking as used herein, is a process of adding noise to data with the objective of the noise conveying some information. In a typical example, watermarking is used in digital content (e.g., audio, video, images, etc.) to verify identity or ownership of the digital content. The idea behind watermarking is the data itself is noise-tolerant and the additional noise or watermarked data does not affect the digital content. The watermarked data is hidden and can be extracted to answer some questions.

The present disclosure includes adding noise, i.e., watermarked data, into the training data with the intent of conveying the legitimacy of the training data to the machine learning model provider. Specifically, the process describes the adding phase by the training data provider, and the process describes the verifying phase by the machine learning model provider. Additional details regarding examples of the watermarked data and the verifying are further described below.

Process for Watermarking Machine Learning Training Data by a Training Data Provider

The watermarking process may include obtaining training data. Again, the training data may be obtained from a controlled environment. The training data may further include historical data and/or simulation data that describes certain aspects of an environment. Those skilled in the art will recognize there are various approaches to creating the training data, all of which are contemplated herewith. Historical data includes data captured in the past from the environment. Simulation data includes data captured based on simulating the environment.

The training data may be used in supervised, unsupervised, and semi-supervised learning. In supervised learning, the training data must be labeled for the training data to allow the model to learn a mapping from the label to its associated features. In unsupervised learning, labels are not required in the training data. Unsupervised machine learning models look for underlying structures in the features of the training data to make generalized groupings or predictions. A semi-supervised training dataset will have a mix of both unlabeled and labeled features, used in semi-supervised learning problems.

The training data can include many different types of data, including structured, unstructured, and semi-structured data. Structured data are data that have clearly defined patterns and data types, whereas unstructured data does not. Structured data is highly organized and easily searchable, usually residing in relational databases. Examples of structured data include sales transactions, inventory, addresses, dates, stock information, etc. Unstructured data, often living in non-relational databases, are more difficult to pinpoint and are most often categorized as qualitative data. Examples of unstructured data include audio recordings, video, tweets, social media posts, satellite imagery, text files, etc. Depending on the machine learning application, both structured and unstructured data can be used as training data.

The process includes verifying the training data based on a use case or application associated therewith. Here, the training data provider determines that the training data is valid, for the use case or application, and is from a trusted source. Now, the training data provider can be the source as well. Alternatively, the training data provider can obtain the training data from another source.

The training data may contain appropriate data for the use case or application. In some embodiments, the training data may be considered appropriate or valid if this data (1) is from or about (i.e., simulated data) the environment, (2) is pertinent to the use case or application, and (3) is legitimate. The first point (1) is this data is historical data from the environment and/or simulated data from a simulation of the environment. That is, the training data is pertinent. In the image classification example of cats vs. dogs, this means the training data is actually images, not executable files, not structured data about a population, etc., i.e., any digital content that is unrelated to images.

The second point (2) means the data reasonably reflects the use case or application. Again, in the image classification example of cats vs. dogs, the training data includes images of cats and dogs, not animals in general, not images of cars vs. planes, etc. In another example, in a health application looking at a population having certain risk factors for a given disease, the data reasonably covers both the population and the risk factors.

Finally, the third point (3) means the data is legitimate, i.e., not malicious, poisoned, adversarial, etc. Again, in the image classification example of cats vs. dogs, the training data includes images of cats and dogs that are labeled properly, i.e., there are not various images of dogs that are labeled as cats and vice versa. Again, those skilled in the art appreciate the in the image classification example of cats vs. dogs is a simplistic example only for illustration purposes.

A verifying step can be done via any approach including manual inspection of some or all of the training data, spot checking of some or all of the training data, unsupervised learning to cluster the training data along with human inspection, automated analysis via a computer, and the like. For example, again in the image classification example of cats vs. dogs, a human operator would look at the images and labels for verification thereof.

Subsequent to verifying the training data, the process includes watermarking the training data by adding watermarked data therein. As described herein, the training data is signed by adding noise, i.e., watermarked data, to the training data. The watermarked data includes entries that are purposefully added to the training data so that a machine learning model provider can verify the legitimacy of the training data, i.e., to convey the results of the verifying step, without requiring the machine learning model provider to perform the verifying step.

Details of the added noise/watermarked data are described below. Of note, the training data is noise-tolerant to some extent, meaning having some bad or meaningless data entries is tolerable and has little effect on the trained machine learning model. Our approach is to include a small amount of noise for the watermarking, such that the added noise is small and the overall signal-to-noise ratio (SNR) of the training data is large and such that a machine learning model provider can use the small amount of noise to determine the legitimacy, veracity, and validity of the underlying data.

In addition to watermarking the training data, there can be another step of signing the watermarked training data. This signing step can be performed in addition to the watermarking step. The signing step can include verifying the training data provider's identity, obtaining a private key, and utilizing the private key to sign the watermarked training data with a digital certificate, such as using a singing engine. The step of verifying the training data provider's identity can be via a remote identity validation process, also referred to as identity proofing utilizing government identification, biometrics, facial recognition, or other mechanism of identity validation. This, in combination with the watermarked data, will prove two things—(1) the training data has been validated by an individual (it is also possible this person's identity has also been validated via remote identity validation), and (2) The valid training data 12 provider uses their client certificate to sign the data.

Finally, the process includes publishing the watermarked training data. The publishing can take any form and a simple example would be to upload to the database, post on the Internet, etc. The publishing can include a description of the use case or application, i.e., training data for image recognition between cats and dogs, etc., as well as a one-way function that can be used to verify the watermarking. Again, more details are presented below regarding the one-way function to verify the watermarking.

Signing and Watermarking

Signing and including the watermarked (noise/fake) data can be two separate steps. In a first example scenario, we want to know that the data is coming from the right source, and we want to know that with a very high probability. In this case, we are not afraid of showing that the data has been signed cryptographically; this by itself could be an indication that we do take security seriously but almost anyone could acquire a certificate and sign their data set. For this reason, the present disclosure contemplates the watermarked data. That is, signing the training data by itself may convey some legitimacy, but as noted above, anyone can get a certificate and sign a data set. In the present disclosure, call it scenario two, we can also require signing of the data in combination with the noise embedded therein. The key here is the noise cannot be faked due to the agreed upon one-way function. If this noise is not presented, then we can conclude that the sender has provided malicious or non-verified data.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A method comprising the steps of:
examining a questionable video of a prominent individual, wherein the questionable video shows the prominent individual speaking;
detecting speech characteristics of the prominent individual from the questionable video;
detecting bodily movements of the prominent individual from the questionable video while the prominent individual is speaking;
comparing the detected speech characteristics and detected bodily movements with reliable baseline characteristics that are certified as authentic; and
based on the comparing step, tagging the questionable video as fake or real.

2. The method of claim 1, wherein the reliable baseline characteristics include authentic speech characteristics and authentic bodily movements derived from a high-resolution video recording of the prominent individual in a controlled setting.

3. The method of claim 2, wherein the authentic speech characteristics include high-resolution voice parameters defining how specific phonemes, words, phrases, and/or sentences are spoken by the prominent individual.

4. The method of claim 3, wherein the authentic bodily movements include movements of one or more of mouth, face, eyes, eyebrows, head, shoulders, arms, hands, fingers, and chest of the prominent individual when the specific phonemes, words, phrases, and/or sentences are spoken.

5. The method of claim 2, wherein the authentic speech characteristics include parameters related to one or more of pronunciation, enunciation, intonation, articulation, volume, pauses, pitch, rate, rhythm, clarity, intensity, timbre, overtones, resonance, breaths, throat clearing, coughs, and regularity of filler sounds and phrases.

6. The method of claim 2, wherein the high-resolution video recording is created while the prominent individual is performing one or more actions selected from the group consisting of a) reading a script, b) reading a script multiple times within a range of different emotions, c) answering questions, d) answering questions multiple times within a range of different emotions, e) responding to prompts, f) telling a story, g) telling a joke, h) describing something the prominent individual likes, i) describing something the prominent individual dislikes, j) laughing, k) singing, l) smiling, and m) frowning.

7. The method of claim 2, further comprising the step of creating a digital certificate of the high-resolution video recording to certify the high-resolution video recording as authentic.

8. The method of claim 2, further comprising the step of detecting parallel correlations between the authentic speech characteristics and the authentic bodily movements.

9. The method of claim 8, further comprising the step of using the parallel correlations as training data to create a model defining the reliable baseline characteristics.

10. The method of claim 1, further comprising the step of determining a percentage of accuracy of the detected speech characteristics and detected bodily movements with respect to the reliable baseline characteristics.

11. The method of claim 10, wherein, when the percentage of accuracy is below a predetermined threshold, the questionable video is tagged as fake, and, when the percentage of accuracy is above the predetermined threshold, the questionable video is tagged as real.

12. The method of claim 1, wherein the step of tagging the questionable video as fake or real includes applying one or more visible and/or hidden watermarks to the questionable video.

13. The method of claim 1, wherein the prominent individual is a celebrity, a famous person, a luminary, an actor, an actress, a musician, a politician, and/or an influencer who is important, well-known, or famous.

14. A non-transitory computer-readable medium for storing a computer program having instructions that enable a processor to perform the steps of:
examining a questionable video of a prominent individual, wherein the questionable video shows the prominent individual speaking;
detecting speech characteristics of the prominent individual from the questionable video;
detecting bodily movements of the prominent individual from the questionable video while the prominent individual is speaking;
comparing the detected speech characteristics and detected bodily movements with reliable baseline characteristics that are certified as authentic; and
based on the comparing step, tagging the questionable video as fake or real.

15. The non-transitory computer-readable medium of claim 14, wherein the reliable baseline characteristics include authentic speech characteristics and authentic bodily movements derived from a high-resolution video recording of the prominent individual in a controlled setting.

16. The non-transitory computer-readable medium of claim 15, wherein the authentic speech characteristics include high-resolution voice parameters defining how specific phonemes, words, phrases, and/or sentences are spoken by the prominent individual, and wherein the authentic bodily movements include movements of one or more of mouth, face, eyes, eyebrows, head, shoulders, arms, hands, fingers, and chest of the prominent individual when the specific phonemes, words, phrases, and/or sentences are spoken.

17. The non-transitory computer-readable medium of claim 15, wherein the authentic speech characteristics include parameters related to one or more of pronunciation, enunciation, intonation, articulation, volume, pauses, pitch, rate, rhythm, clarity, intensity, timbre, overtones, resonance, breaths, throat clearing, coughs, and regularity of filler sounds and phrases.

18. The non-transitory computer-readable medium of claim 15, wherein the high-resolution video recording is created while the prominent individual is performing one or more actions selected from the group consisting of a) reading a script, b) reading a script multiple times within a range of different emotions, c) answering questions, d) answering questions multiple times within a range of different emotions, e) responding to prompts, f) telling a story, g) telling a joke, h) describing something the prominent individual likes, i) describing something the prominent individual dislikes, j) laughing, k) singing, l) smiling, and m) frowning.

19. The non-transitory computer-readable medium of claim 15, wherein the instructions further enable the processor to perform the step of creating a digital certificate of the high-resolution video recording to certify the high-resolution video recording as authentic.

20. The non-transitory computer-readable medium of claim 15, wherein the instructions further enable the processor to perform the steps of:
detecting parallel correlations between the authentic speech characteristics and the authentic bodily movements; and
using the parallel correlations as training data to create a model defining the reliable baseline characteristics.
